(19) United States
(12) Patent Application Publication
(10) Pub. No.: US 2025/0081883 A1
(43) Pub. Date: Mar. 13, 2025

(54) TURNING CONTROL METHOD FOR SELF-MOVING MACHINE AND SELF-MOVING MACHINE

(71) Applicant: SHENZHEN HANYANG TECHNOLOGY CO., LTD., Shenzhen (CN)

(72) Inventors: Yang HUANG, Shenzhen (CN); Chuwei ZHENG, Shenzhen (CN)

(73) Assignee: SHENZHEN HANYANG TECHNOLOGY CO., LTD., Shenzhen (CN)

(21) Appl. No.: 18/824,739

(22) Filed: Sep. 4, 2024

Related U.S. Application Data
(63) Continuation of application No. PCT/CN2023/129982, filed on Nov. 6, 2023.

(30) Foreign Application Priority Data
Sep. 11, 2023 (CN) 202311172327.2

(51) Int. Cl. A01D 34/00; A01D 101/00; G05D 1/648; G05D 105/15

(52) U.S. Cl. CPC A01D 34/006; G05D 1/648; A01D 2101/00; G05D 2105/15

(57) ABSTRACT

A turning control method of a self-moving machine includes the following steps: acquiring a whole area where the self-moving machine moves; determining an initial turning point based on the whole area; when the self-moving machine reaches the initial turning point, controlling the self-moving machine to move back to a target turning point; and controlling the self-moving machine to turn at the target turning point according to a preset turning path to reach a target point in the whole area.

### CROSS-REFERENCE TO RELATED APPLICATIONS

This application is a continuation of International Application No. PCT/CN2023/129982, filed on Nov. 6, 2023, which claims priority to Chinese Patent Application No. 202311172327.2, filed on Sep. 11, 2023, the contents of which are incorporated herein by reference in their entireties.

### TECHNICAL FIELD

The application relates to the technical field of self-moving machine control, in particular to a turning control method for a self-moving machine and a self-moving machine.

### BACKGROUND

When the self-moving machine is working, it can move and perform certain tasks, such as mowing grass and cleaning snow.

The inventors realized that the steering mode of the existing self-moving machine during cleaning or mowing is turning around its own center. For example, when mowing the lawn mower, because of the crawler structure, the self-moving machine is heavy, the front of the machine is large, and the resistance of the grass is large, the grass will be twisted off by the large torsion when the machine turns around its own center.

### SUMMARY

The main purpose of the application is to provide a turning control method for a self-moving machine and a self-moving machine, aiming at addressing the technical problem of poor turning control effect of the self-moving machine in the prior art.

In order to achieve the above object, the application provides a turning control method for a self-moving machine, which includes the following steps:
acquiring a whole area where the self-moving machine moves;
determining an initial turning point based on the whole area;
controlling, when the self-moving machine reaches the initial turning point, the self-moving machine to move back to a target turning point; and
controlling the self-moving machine to turn at the target turning point according to a preset turning path to reach a target point in the whole area.

In addition, in order to achieve the above purpose, the application also provides a turning control device for a self-moving machine, which includes:
an acquisition module, configured for acquiring a whole area where the self-moving machine moves;
a determination module, configured for determining an initial turning point based on the whole area;
a control module, configured for controlling, when the self-moving machine reaches the initial turning point, the self-moving machine to move back to a target turning point; and
wherein the control module is further configured for controlling the self-moving machine to turn at the target turning point according to a preset turning path to reach a target point in the whole area.

Moreover, in order to achieve the above purpose, the application further provides a self-moving machine, including a head, a body, a moving machine and a controller, the head is detachably connected to the body, the moving machine and the controller are arranged on the body, the controller is used for controlling the moving machine to turn, the controller is able to run a turning control program of the self-moving machine, and the turning control program of the self-moving machine is configured to further realize the steps of the turning control method for a self-moving machine described above.

The present application is realized as follows: acquiring a whole area where the self-moving machine moves; determining an initial turning point based on the whole area; controlling, when the self-moving machine reaches the initial turning point, the self-moving machine to move back to a target turning point; and controlling the self-moving machine to turn at the target turning point according to a preset turning path to reach a target point in the whole area. By controlling the self-moving machine to move back and then turn, the turning effect is improved while preventing irreversible harm to the grass.

Details of one or more embodiments of the application are set forth in the following drawings and descriptions, and other features and advantages of the application will be apparent from the description, drawings and claims.

### BRIEF DESCRIPTION OF THE DRAWINGS

FIG. 1 is a flow chart of a turning control method for a self-moving machine according to a first embodiment of the present application.

FIG. 2 is a schematic diagram of the division of a whole area of a turning control method for a self-moving machine according to an embodiment of the present application.

FIG. 3 is a schematic diagram of an initial turning point and a target turning point of a turning control method for a self-moving machine according to an embodiment of the present application.

FIG. 4 is a schematic diagram for controlling the self-moving machine to turn at the target turning point according to a preset turning path to reach a target point in the whole area, according to an embodiment of the present application.

FIG. 5 is a schematic flow chart of a turning control method for a self-moving machine according to a second embodiment of the present application.

FIG. 6 is a schematic diagram of a preset turning path of a turning control method for a self-moving machine according to an embodiment of the present application.

FIG. 7 is a schematic flow chart of a turning control method for a self-moving machine according to the third embodiment of the present application.

FIG. 8 is a schematic diagram of a turning point and a target point of a turning control method for a self-moving machine according to an embodiment of the present application.

FIG. 9 is a schematic flow chart of a turning control method for a self-moving machine according to the fourth embodiment of the present application.

FIG. 10 is a schematic flow chart of a turning control method for a self-moving machine according to the fifth embodiment of the present application.

FIG. 11 is a structural diagram of a turning control device for a self-moving machine according to a first embodiment of the present application.

The purposes, implementations, technical features and advantages of the application will be further explained with reference to the attached drawings and embodiments.

### DETAILED DESCRIPTION OF THE EMBODIMENTS

It should be understood that the specific embodiments described herein are merely intended to clarify the application rather than limit it.

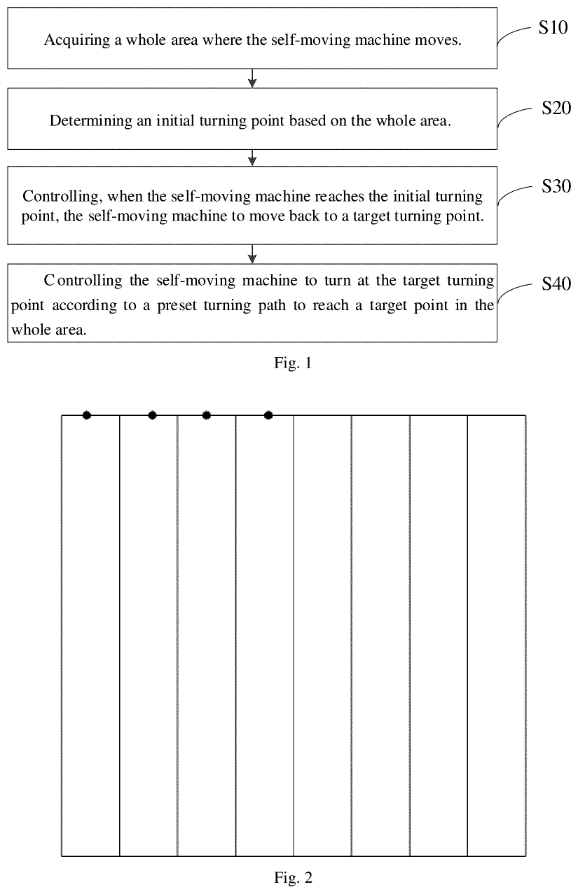

Referring to FIG. 1, a flow chart of a turning control method for a self-moving machine according to a first embodiment of the present application is provided.

In this embodiment, the turning control method for a self-moving machine includes the following steps.

Step S10: acquiring a whole area where the self-moving machine moves.

It should be noted that the device of this embodiment may be a turning control device for a self-moving machine, and may also be other devices that can achieve the same or similar functions. This embodiment does not restrict this, and it explains using the self-moving equipment's turning control mechanism as an example.

In specific implementation, the self-moving machine may be a lawn mower, a snow cleaner, a mopping machine, etc. The lawnmower is used as an example in this embodiment, but it is not restricted to this.

The whole area where the self-moving machine moves may be the area that needs to be mowed by the lawn mower. Before mowing, the lawn mower can be controlled to move around to capture the area on the map, and finally a whole working area is formed.

Most of the paths of the existing lawn mower are parallel, requiring two consecutive 90-degree turns to connect two adjacent paths. If the lawn mower turns around its own center, the grass will be severely worn and irreversibly damaged.

In this embodiment, the original turn is divided into Bezier curves, with a turning circle radius of 0.5 to 1 m. This allows two adjacent parallel paths to be coherently connected through two Bezier curves and two back-moving actions, improving the turning effect, smoothing the turning trajectory, enhancing the moving smoothness, and preventing irreversible damage to the grass.

Step S20: determining an initial turning point based on the whole area.

It should be noted that after acquiring a whole area where the self-moving machine moves, the whole area can be divided to determine the initial turning point of the lawn mower. In the moving process of the lawn mower, the position of obstacles can be determined in advance to avoid turning many times for the self-moving machine.

In an embodiment, the step of determining an initial turning point based on the whole area specifically includes: dividing the whole area to obtain data of a plurality of moving paths; acquiring, when the self-moving machine moves, boundary point data based on the whole area; and determining an initial turning point based on the data of the plurality of moving paths and the boundary point data.

It should be noted that the whole area can be divided into a plurality of moving paths when the mower moves according to the working conditions of the mower, for example, the distance between paths is in the range of 30-60 cm, and the working boundary points are determined during the moving of the mower, so that the initial turning point can be determined according to the data of the plurality of moving paths and the boundary point data, and the number of the initial turning points is 1. As shown in FIG. 2, which is a schematic diagram of the division of the whole area. By dividing the whole area into a plurality of moving paths, and obtaining the boundary point according to the whole area, i.e. the black dots in FIG. 2, the points that the self-moving machine is supposed to turn, i.e. the initial turning point, can be determined by the moving paths of the lawn mower and the boundary points.

Step S30: controlling, when the self-moving machine reaches the initial turning point, the self-moving machine to move back to a target turning point.

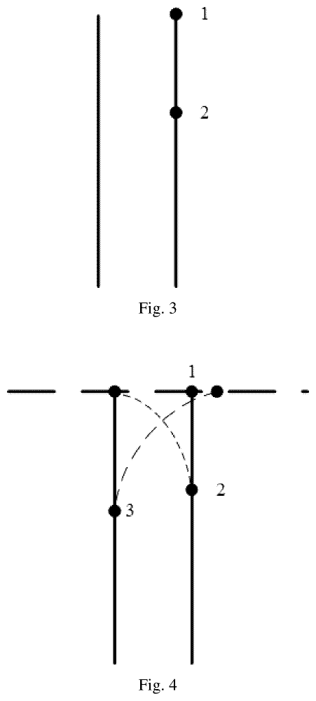

It should be noted that when the self-moving machine reaches the initial turning point, the self-moving machine needs to turn, but turning at the initial turning point means turning around its own center, which will seriously wear the grass. In this case, the self-moving machine can be controlled to move back to the target turning point, as shown in FIG. 3, which is a schematic diagram of the initial turning point and the target turning point. In FIG. 3, point 1 is the initial turning point and point 2 is the target turning point. After the mower reaches point 1, it is controlled to move back to the target turning point.

Step S40: controlling the self-moving machine to turn at the target turning point according to a preset turning path to reach a target point in the whole area.

It should be understood that when the self-moving machine reaches the target turning point, it can be controlled to turn, for example, the self-moving machine is controlled, and the preset turning path may be a second-order Bezier curve. By controlling the self-moving machine to turn at the target turning point, the target point in the whole area can be reached, as shown in FIG. 4, which is a schematic diagram a schematic diagram for controlling the self-moving machine to turn at the target turning point according to a preset turning path to reach a target point in the whole area. In FIG. 4, point 1 is the initial turning point, point 2 is the target turning point, and point 3 is the target point in the whole area. By turning at point 2 according to the preset turning path, point 3 is reached.

This embodiment is realized as follows: acquiring a whole area where the self-moving machine moves;

determining an initial turning point based on the whole area; controlling, when the self-moving machine reaches the initial turning point, the self-moving machine to move back to a target turning point; and controlling the self-moving machine to turn at the target turning point according to a preset turning path to reach a target point in the whole area. By controlling the self-moving machine to move back and then turn, the turning effect is improved while preventing irreversible harm to the grass.

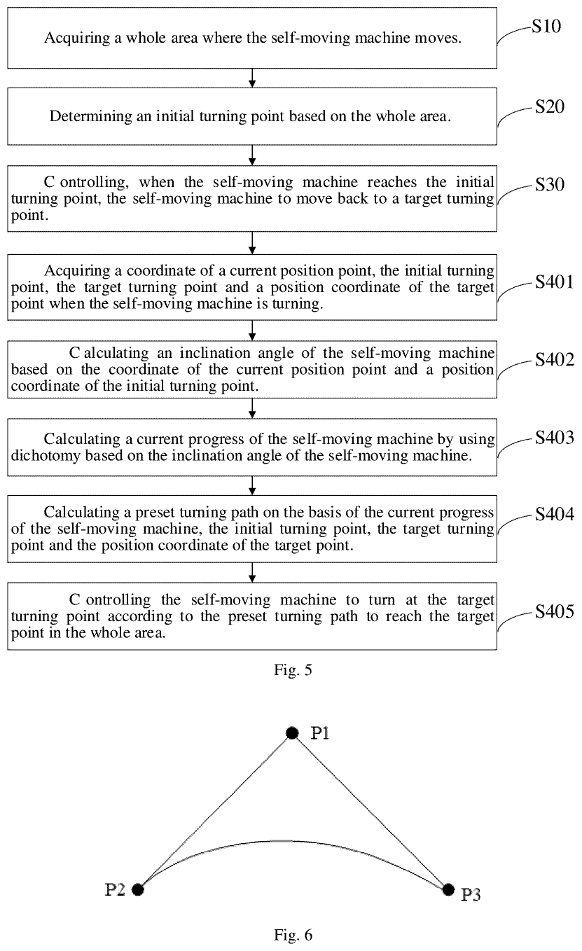

Referring to FIG. 5, a schematic flow chart of a turning control method for a self-moving machine according to a second embodiment of the present application is provided.

Based on the first embodiment, the step S40 of the turning control method for a self-moving machine in this embodiment specifically includes:

Step S401: acquiring a coordinate of a current position point, the initial turning point, the target turning point and a position coordinate of the target point when the self-moving machine is turning.

It should be noted that in the turning process of the self-moving machine, the real-time coordinate of the current position point of the self-moving machine can be obtained, and the initial turning point P1, the target turning point P2 and the position coordinate of the target point P3 can be obtained.

Step S402: calculating an inclination angle of the self-moving machine based on the coordinate of the current position point and a position coordinate of the initial turning point.

In the specific implementation, the inclination angle of the self-moving machine can be calculated based on the coordinate of the current position point and the position coordinate of the initial turning point, which can be calculated using the inverse trigonometric function.

Step S403: calculating a current progress of the self-moving machine by using dichotomy based on the inclination angle of the self-moving machine.

In the specific implementation, the current progress of the self-moving machine can be obtained by using dichotomy based on the inclination angle of the self-moving machine, for example, the inclination angle after calculation is compared with the middle value of the current inclination range. If the calculated inclination angle is within the current inclination angle range, it means that the target point is within this range, indicating half of the progress; otherwise, the target point is in the other half of the inclination angle range. In this way, the current progress of the self-moving machine is obtained.

Step S404: calculating a preset turning path based on the current progress of the self-moving machine, the initial turning point, the target turning point and the position coordinate of the target point.

It should be noted that the path of the second-order Bezier curve is traced by the function B (t) of the given points P1, P2 and P3, and the initial turning point P1, the target turning point P2 and the target point P3 form a 90-degree turn, which corresponds to a 90-degree turn in a three-point turn, and is smoothed into a Bezier curve, thus making the lawn mower control smoother and more stable.

As shown in FIG. 6, which is a schematic diagram of the preset turning path. After the current progress of the self-moving machine is obtained, the path point data during turning can be calculated by the current progress of the self-moving machine, the initial turning point, the target turning point and the position coordinate of the target point, and all the path point data are connected to form the preset turning path.

The formula for calculating the path point data is as follows:

B(t)=(1−t)2*P1+2(1−t)t*P2+t2*P3 (Formula 1)

In Formula 1, B (t) represents the path point data, t represents the current progress of the self-moving machine, which can be calculated by using dichotomy based on the inclination angle of the self-moving machine. P1, P2 and P3 represent the initial turning point, the target turning point and the position coordinate of the target point.

Step S405: controlling the self-moving machine to turn at the target turning point according to the preset turning path to reach the target point in the whole area.

In the specific implementation, after calculating the preset turning path, the self-moving machine can be controlled to turn at the target turning point according to the preset turning path, so as to reach the target point in the whole area.

This embodiment is realized as follows: acquiring a coordinate of a current position point, the initial turning point, the target turning point and a position coordinate of the target point when the self-moving machine is turning; calculating an inclination angle of the self-moving machine according to the coordinate of the current position point and a position coordinate of the initial turning point; calculating a current progress of the self-moving machine by using dichotomy based on the inclination angle of the self-moving machine; calculating a preset turning path based on the current progress of the self-moving machine, the initial turning point, the target turning point and the position coordinate of the target point; and controlling the self-moving machine to turn at the target turning point according to the preset turning path to reach the target point in the whole area. By controlling the self-moving machine to turn according to the preset turning path, the turning control process of the self-moving machine is more stable and smoother.

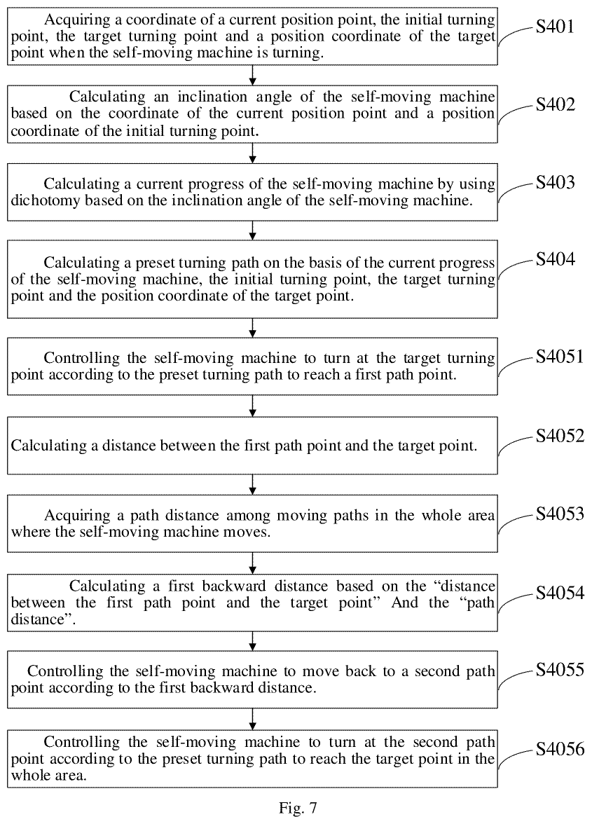

Referring to FIG. 7, a schematic flow chart of a turning control method for a self-moving machine according to the third embodiment of the present application is provided.

Based on the first embodiment, the step S405 of the turning control method for a self-moving machine in this embodiment specifically includes:

Step S4051: controlling the self-moving machine to turn at the target turning point according to the preset turning path to reach a first path point.

It should be noted that when the self-moving machine is turning, it is impossible to directly control the completion of turning. It is necessary to control the self-moving machine to turn for the first time according to the preset turning path and reach the first path point, which is the position point reached by the first turn.

Step S4052: calculating a distance between the first path point and the target point.

In the specific implementation, after the self-moving machine is controlled to reach the first path point, it will make another turn to reach the target point of the whole area, and the self-moving machine will be controlled to move back at the first path point, and then turn according to the preset path to reach the target point in the whole area. Thus, the distance between the first path point and the target point can be calculated. The distance L1 between the first path point and the target point can be measured.

Step S4053: acquiring a path distance among moving paths in the whole area where the self-moving machine moves.

It should be noted that the path distance between the moving paths of the self-self-moving machine is the distance between the moving paths in the divided whole area, that is, L2.

Step S4054: calculating a first backward distance based on the “distance between the first path point and the target point” and the “path distance”.

In the specific implementation, the first backward distance H1 is related to the distance L1 between the first path point and the target point, so the first backward distance can be calculated from the distance L1 between the first path point and the target point and the path distance L2, and the first backward distance is H1=2L1−L2.

Step S4055: controlling the self-moving machine to move back to a second path point according to the first backward distance.

In the specific implementation, the second path point can be reached by controlling the self-moving machine to move back to the “first backward distance”.

Step S4056: controlling the self-moving machine to turn at the second path point according to the preset turning path to reach the target point in the whole area.

In the specific implementation, the self-moving machine can be controlled to continue turning at the second path point according to the preset turning path to reach the target point in the whole area.

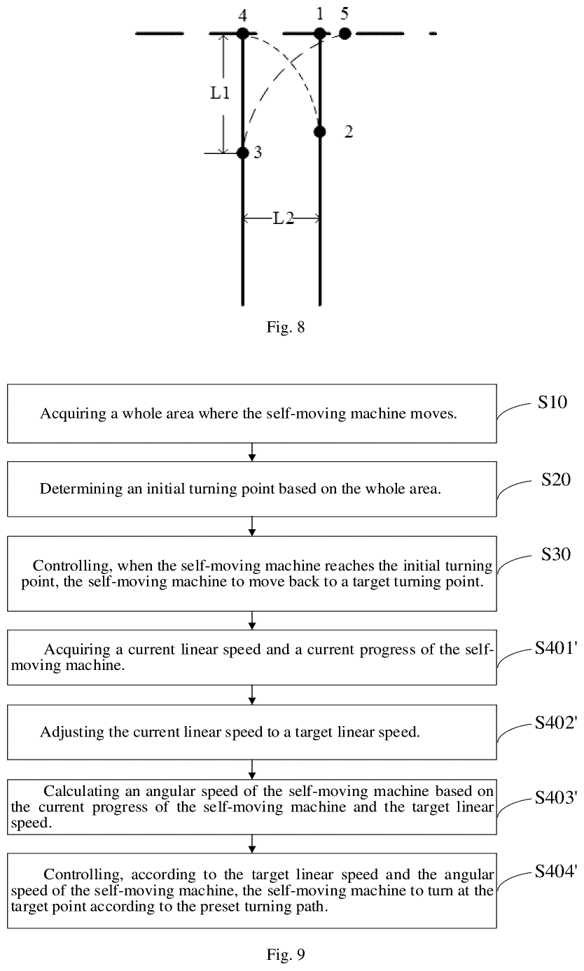

As shown in FIG. 8, which is a schematic diagram of a turning point and a target point, point 1 is the initial turning point, point 2 is the target turning point, point 3 is the target point, point 4 is the first path point, and point 5 is the second path point. Point 5 and point 1 may overlap (when the radius of turning circle is too large, there will be a problem of non-overlapping). When the self-self-moving machine move back to the target turning point at the initial turning point, the self-moving machine is controlled to turn to the first path point 4 at the target turning point according to the preset turning path, move back to the second path point 5 at the first path point 4, and turn to the target point 3 at the second path point 5 according to the preset turning path. In this way, the overall turning control process of the self-moving machine is completed.

This embodiment is realized as follows: controlling the self-moving machine to turn at the target turning point according to the preset turning path to reach a first path point; calculating a distance between the first path point and the target point; acquiring a path distance among moving paths in the whole area where the self-moving machine moves; calculating a first backward distance based on the “distance between the first path point and the target point” and the “path distance”; controlling the self-moving machine to move back to a second path point according to the first backward distance; and controlling the self-moving machine to turn at the second path point according to the preset turning path to reach the target point in the whole area. By continuously controlling the self-moving machine to move back and turn, the turning control effect of the self-moving machine can be improved.

Referring to FIG. 9, a schematic flow chart of a turning control method for a self-moving machine according to the fourth embodiment of the present application is provided.

Based on the first embodiment, the step S40 of the turning control method for a self-moving machine of this embodiment includes:

Step S401′: acquiring a current linear speed and a current progress of the self-moving machine.

It should be noted that when the self-moving machine is controlled to turn, in order to make the turning of the self-moving machine smoother and more stable, it needs to control the turning speed of the self-moving machine, then the current linear speed and the current progress of the self-moving machine can be obtained, and the current progress of the self-moving machine can be calculated by using dichotomy based on the inclination angle of the self-moving machine. The current linear speed of the self-moving machine can be acquired by speed sensors or other measuring instruments.

Step S402′: adjusting the current linear speed to a target linear speed.

In the specific implementation, the target linear speed can be set in advance, and the target linear speed is smaller than the current linear speed of the self-moving machine, thus avoiding the self-moving machine from turning out of control due to excessive speed.

For example, if the current linear speed is 0.3 m/s and the preset linear speed is 0.2 m/s, the current linear speed will be adjusted to the target linear speed, which is the adjusted speed, 0.2 m/s.

Step S403′: calculating an angular speed of the self-moving machine based on the current progress of the self-moving machine and the target linear speed.

In the specific implementation, the angular speed of the self-moving machine can be calculated based on the target linear speed “v” and the current progress “t” of the self-moving machine. Specifically, the radius of turning circle of the self-moving machine when turning can be calculated based on the current progress “t” of the self-moving machine, so that the angular speed of the self-moving machine can be calculated based on the radius of turning circle and the target linear speed, and the angular speed of the self-moving machine is w=v/r.

In an embodiment, it is realized as follows: calculating, based on the current progress of the self-moving machine, position values of the self-moving machine reaching a first position point and a second position point during turning and a radian relative to the current position point of the self-moving machine during turning; calculating the radius of turning circle based on the radian and the position values of the first position point and the second position point; calculating the angular speed of the self-moving machine based on the target linear speed and the radius of turning circle.

It should be understood that the position values of the first position point and the second position point reached by the self-moving machine when turning can be calculated based on the current progress “t” and B(t) function, where the position value of the first position point is B1=B (t−0.05), the position value of the second position point is B2=B (t+0.05), and the radian of the current position point of the self-moving machine during turning is B=rad(B2−B1).

In the specific implementation, the distance dis(B2−B1) between the first position point and the second position point can be calculated based on the radian rad(B2−B1), the position value of the first position point B1 and the position value of the second position point B2, and then the radius of turning circle of the self-moving machine is r=dis(B2−B1)/rad(B2−B1).

In the specific implementation, the angular speed of the self-moving machine can be calculated based on the target linear speed “v” and the radius of turning circle “r”, and the angular speed of the self-moving machine is w=v/r.

It should be noted that in the case that the ground is slippery, there will be some deviation of the self-moving machine during the process of controlling it to turn, such as position deviation or angle deviation. Therefore, it is necessary to calculate the deviation of self-moving machine when turning for more accurate angular speed.

The step of calculating the angular speed of the self-moving machine based on the target linear speed and the radius of turning circle includes the following steps: acquiring a current body orientation, a current body position and a target position of the self-moving machine when turning; calculating an included angle between straight lines where the body orientation and the target position are located based on the current body orientation and the target position to obtain an angular difference; calculating a difference between the current body position and the target position to obtain a position deviation; and calculating the angular speed of the self-moving machine based on the target linear speed, the radius of turning circle, the angular difference and the position deviation.

In the specific implementation, the current body orientation, current body position and the target position of the self-moving machine during turning can be obtained, so as to acquire the included angle between straight lines where the body orientation and the target position are located. The target position of the self-moving machine when turning is the ideal position when the self-moving machine is controlled to turn.

The included angle between the straight lines where the heading angle and the target position are located can be calculated by obtaining a heading angle of the current body orientation, and the distance difference between the current body position and the target position can be calculated to obtain the position deviation. The target position can be located at any point on the preset turning path. When the self-moving machine needs to go to the target position, it can be controlled to move to the target position with the current body orientation and the current body position. However, if the ground is slippery or uneven in the control process, there would be a certain deviation when the self-moving machine moves, and the distance difference between the current body position and the target position is a positive and negative value.

In the specific implementation, the angular difference and position deviation can be adjusted by PID for the calculation of the angular speed of self-moving machine. The angular speed of self-moving machine is w=v/r+PID (angErr)+PID (posErr), where the angErr value controlled by PID is the angular difference, and the posErr value controlled by PID is the position deviation.

Step S404′: controlling, according to the target linear speed and the angular speed of the self-moving machine, the self-moving machine to turn at the target point according to the preset turning path.

In the specific implementation, the self-moving machine can be controlled to turn according to the preset turning path with the target linear speed and the angular speed of the self-moving machine, and the faster the angular speed is, the faster the linear speed needs to drop. And in the turning process of the self-moving machine, there will be a situation that one wheel is fast and the other wheel is slow, so after calculating the angular speed of the self-moving machine, the wheel distance “d” between the two wheels of the self-moving machine should be obtained, so the speeds of the left and right wheels can be calculated respectively. The left and right wheel speeds are calculated with the following formula 2:

$$v 1 = v + \frac{w * d}{2} v 2 = v - \frac{w * d}{2} \qquad ( Formula 2 )$$

In Formula 2, v1 is the right wheel speed, v2 is the left wheel speed, d is the wheel distance, v is the target linear speed, and w is the angular speed of the self-moving machine. The lawn mower is controlled to turn according to the calculated left wheel speed and right wheel speed, and the turning effect is improved.

This embodiment is realized as follows: acquiring a current linear speed and a current progress of the self-moving machine; adjusting the current linear speed to a target linear speed, he power of the motor can be reduced; calculating an angular speed of the self-moving machine based on the current progress of the self-moving machine and the target linear speed; and controlling, according to the target linear speed and the angular speed of the self-moving machine, the self-moving machine to turn at the target point according to the preset turning path. In this way, the self-moving machine is controlled to turn according to the preset turning path, and the stability of turning is improved.

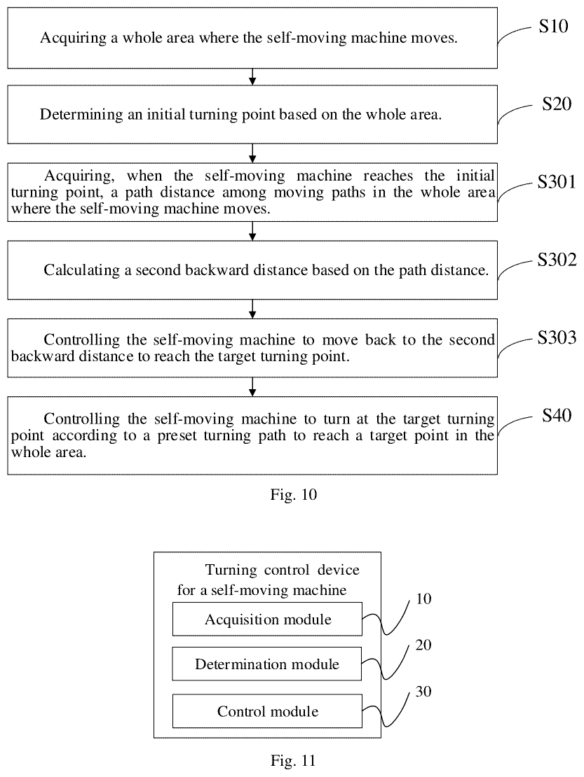

Referring to FIG. 10, a schematic flow chart of a turning control method for a self-moving machine is provided.

Based on the first embodiment, the step S30 of the turning control method for a self-moving machine in this embodiment specifically includes:

Step S301: acquiring, when the self-moving machine reaches the initial turning point, a path distance among moving paths in the whole area where the self-moving machine moves.

It should be noted that this solution adopts the three-point turning control, and the initial turning point is the boundary point where the self-moving machine moves to a certain path. The path distance between the moving paths in the whole area where the self-moving machine moves can be obtained, the path distance may be any value within the range of 30 cm-60 cm, and the path distances among the moving paths may be the same or different.

Step S302: calculating a second backward distance based on the path distance.

In the specific implementation, the second backward distance is the distance that the lawn mower moves backs after reaching the initial turning point, and the second backward distance H2 could be half of the path distance L2.

Step S303: controlling the self-moving machine to move back to the second backward distance to reach the target turning point.

It can be understood that when the second backward distance H2 is calculated, the self-moving machine can be controlled to move back to the second backward distance, so as to reach the target turning point, and the distance between the initial turning point and the target turning point is the second backward distance.

This embodiment is realized as follows: acquiring, when the self-moving machine reaches the initial turning point, a path distance among moving paths in the whole area where the self-moving machine moves; calculating a second backward distance based on the path distance; and controlling the self-moving machine to move back to the second backward distance to reach the target turning point. In this way, by controlling the self-moving machine to move back to the target turning point, the self-moving machine is controlled to turn at the target turning point, thereby improving the turning effect.

Referring to FIG. 11, a structural diagram of a turning control device for a self-moving machine according to a first embodiment of the present application is provided.

As shown in FIG. 11, the turning control device for a self-moving machine proposed by the embodiment of the present application includes:

an acquisition module 10, configured for acquiring a whole area where the self-moving machine moves;

a determination module 20, configured for determining an initial turning point based on the whole area;

a control module 30, configured for controlling, when the self-moving machine reaches the initial turning point, the self-moving machine to move back to a target turning point; and

the control module 30 is further configured for controlling the self-moving machine to turn at the target turning point according to a preset turning path to reach a target point in the whole area.

This embodiment is realized as follows: acquiring a whole area where the self-moving machine moves;
determining an initial turning point based on the whole area; controlling, when the self-moving machine reaches the initial turning point, the self-moving machine to move back to a target turning point; and controlling the self-moving machine to turn at the target turning point according to a preset turning path to reach a target point in the whole area. By controlling the self-moving machine to move back and then turn, the turning effect is improved while preventing irreversible harm to the grass.

In an embodiment, the control module 30 is further configured for acquiring a coordinate of a current position point, the initial turning point, the target turning point and a position coordinate of the target point when the self-moving machine is turning; calculating an inclination angle of the self-moving machine according to the coordinate of the current position point and a position coordinate of the initial turning point; calculating a current progress of the self-moving machine by using dichotomy based on the inclination angle of the self-moving machine; calculating a preset turning path based on the current progress of the self-moving machine, the initial turning point, the target turning point and the position coordinate of the target point; and controlling the self-moving machine to turn at the target turning point according to the preset turning path to reach the target point in the whole area.

In an embodiment, the control module 30 is further configured for controlling the self-moving machine to turn at the target turning point according to the preset turning path to reach a first path point; calculating a distance between the first path point and the target point; acquiring a path distance among moving paths in the whole area where the self-moving machine moves; calculating a first backward distance based on the “distance between the first path point and the target point” and the “path distance”; controlling the self-moving machine to move back to a second path point according to the first backward distance; and controlling the self-moving machine to turn at the second path point according to the preset turning path to reach the target point in the whole area.

In an embodiment, the control module 30 is further configured for acquiring a current linear speed and a current progress of the self-moving machine; adjusting the current linear speed to a target linear speed; calculating an angular speed of the self-moving machine based on the current progress of the self-moving machine and the target linear speed; and controlling, according to the target linear speed and the angular speed of the self-moving machine, the self-moving machine to turn at the target point according to the preset turning path.

In an embodiment, the control module 30 is further configured for calculating, based on the current progress of the self-moving machine, position values of the self-moving machine reaching a first position point and a second position point during turning and a radian relative to the current position point of the self-moving machine during turning; calculating the radius of turning circle based on the radian and the position values of the first position point and the second position point; calculating the angular speed of the self-moving machine based on the target linear speed and the radius of turning circle.

In an embodiment, the control module 30 is further configured for acquiring a current body orientation, a current body position and a target position of the self-moving machine when turning; calculating an included angle between straight lines where the body orientation and the target position are located based on the current body orientation and the target position to obtain an angular difference; calculating a difference between the current body position and the target position to obtain a position deviation; and calculating the angular speed of the self-moving machine based on the target linear speed, the radius of turning circle, the angular difference and the position deviation.

In an embodiment, the control module 30 is further configured for acquiring, when the self-moving machine reaches the initial turning point, a path distance among moving paths in the whole area where the self-moving machine moves; calculating a second backward distance based on the path distance; and controlling the self-moving machine to move back to the second backward distance to reach the target turning point.

In an embodiment, the determination module 20 is further configured for dividing the whole area to obtain data of a plurality of moving paths; acquiring, when the self-moving machine moves, boundary point data based on the whole area; and determining an initial turning point based on the data of the plurality of moving paths and the boundary point data.

In addition, in order to achieve the above purpose, the application further provides a self-moving machine, which includes a head, a body, a moving machine and a controller, wherein the head is detachably connected to the body, the moving machine and the controller are arranged on the body, the controller is used for controlling the moving machine to turn, the controller is able to run a turning control program of the self-moving machine, and the turning control program of the self-moving machine is configured to further realize the steps of the turning control method for a self-moving machine described above.

The self-moving machine adopts all the technical solutions of all the above embodiments, it has at least all the beneficial effects brought by the technical solutions of the above embodiments, which will not be repeated here.

It should be understood that the aforementioned are merely examples and do not impose any restrictions on the technical solution of the present application. In specific applications, those skilled in the art can customize arrangements according to actual needs, which is not limited by the present application.

It should be noted that the workflow described above is only schematic and does not limit the protection scope of this application. In practical application, those skilled in the art can choose some or all of them to achieve the purpose of this embodiment solution according to actual needs, which is not limited by the present application.

In addition, for the technical details that are not described in detail in this embodiment, please refer to the turning control method for a self-moving machine provided by any embodiment of this application, which will not be repeated here.

In addition, it should be noted that in this paper, the terms “comprise”, “include” or any other variation thereof are intended to cover non-exclusive subject-matter. A process, method, article or system including a series of elements includes not only those elements, but also other elements not explicitly listed, or elements inherent to such process, method, article or system. Without more restrictions, an element defined by the phrase “comprising a” does not exclude the existence of other identical elements in the process, method, article or system.

The above numbers of the embodiments of the present application are only for description, and do not indicate priorities of the embodiments.

With the description of the above embodiments, those skilled in the art can clearly understand that the methods of the above embodiments can be realized by means of software and necessary general hardware platform. Alternatively, they can be realized by hardware, but in many cases, the former is the better one. Based on this understanding, the technical solution of this application can be embodied in the form of a software product, which is stored in a storage medium, such as Read Only Memory (ROM), RAM, magnetic disk, optical disk, etc., and includes several instructions to enable a terminal device (e.g., mobile phone, computer, server, or network device, etc.) to execute the methods described in the embodiments of this application.

The above are merely the preferred embodiments of the present application, they do not restrict the patent scope of this application. Any equivalent structure or equivalent process transformation made with the contents of this application description and drawings, or directly or indirectly used in other related technical fields, shall be included in the patent protection scope of this application.

What is claimed is:

1. A turning control method for a self-moving machine, comprising:
acquiring a whole area where the self-moving machine moves;
determining an initial turning point based on the whole area;
controlling, when the self-moving machine reaches the initial turning point, the self-moving machine to move back to a target turning point; and
controlling the self-moving machine to turn at the target turning point according to a preset turning path to reach a target point in the whole area.

2. The turning control method for the self-moving machine of claim 1, wherein the step of controlling the self-moving machine to turn at the target turning point according to a preset turning path to reach a target point in the whole area comprises:
acquiring a coordinate of a current position point, the initial turning point, the target turning point and a position coordinate of the target point when the self-moving machine is turning;
calculating an inclination angle of the self-moving machine based on the coordinate of the current position point and a position coordinate of the initial turning point;
calculating a current progress of the self-moving machine by using dichotomy based on the inclination angle of the self-moving machine;
calculating a preset turning path based on the current progress of the self-moving machine, the initial turning point, the target turning point and the position coordinate of the target point; and
controlling the self-moving machine to turn at the target turning point according to the preset turning path to reach the target point in the whole area.

3. The turning control method for the self-moving machine of claim 2, wherein the step of calculating a preset turning path based on the current progress of the self-moving machine, the initial turning point, the target turning point and the position coordinate of the target point comprises:
calculating path point data when turning based on the current progress of the self-moving machine, the initial turning point, the target turning point and the position coordinate of the target point; and
connecting all the path point data to form the preset turning path.

4. The turning control method for the self-moving machine of claim 3, wherein the path point data is expressed as: B(t)=(1−t)2*P1+2(1−t)t*P2+t2*P3; wherein t represents the current progress of the self-moving machine, and P1, P2 and P3 represent the initial turning point, the target turning point and the position coordinate of the target point.

5. The turning control method for the self-moving machine of claim 2, wherein the step of controlling the self-moving machine to turn at the target turning point according to the preset turning path to reach the target point in the whole area comprises:
controlling the self-moving machine to turn at the target turning point according to the preset turning path to reach a first path point;
calculating a distance between the first path point and the target point;
acquiring a path distance among moving paths in the whole area where the self-moving machine moves;
calculating a first backward distance based on the “distance between the first path point and the target point” and the “path distance”;
controlling the self-moving machine to move back to a second path point according to the first backward distance; and
controlling the self-moving machine to turn at the second path point according to the preset turning path to reach the target point in the whole area.

6. The turning control method for the self-moving machine of claim 1, wherein the step of controlling the self-moving machine to turn at the target turning point according to a preset turning path to reach a target point in the whole area comprises:
acquiring a current linear speed and a current progress of the self-moving machine;
adjusting the current linear speed to a target linear speed;
calculating an angular speed of the self-moving machine based on the current progress of the self-moving machine and the target linear speed; and
controlling, according to the target linear speed and the angular speed of the self-moving machine, the self-moving machine to turn at the target point according to the preset turning path.

7. The turning control method for the self-moving machine of claim 6, wherein the step of calculating an angular speed of the self-moving machine based on the current progress of the self-moving machine and the target linear speed comprises:
calculating, when the self-moving machine is turning, a radius of turning circle based on the current progress of the self-moving machine; and
calculating the angular speed of the self-moving machine based on the radius of turning circle and the target linear speed.

8. The turning control method for the self-moving machine of claim 6, wherein the step of calculating an angular speed of the self-moving machine based on the current progress of the self-moving machine and the target linear speed comprises:
calculating, based on the current progress of the self-moving machine, position values of the self-moving machine reaching a first position point and a second position point during turning and a radian relative to the current position point of the self-moving machine during turning;
calculating the radius of turning circle based on the radian and the position values of the first position point and the second position point; and
calculating the angular speed of the self-moving machine based on the target linear speed and the radius of turning circle.

9. The turning control method for the self-moving machine of claim 8, wherein the step of calculating the angular speed of the self-moving machine based on the target linear speed and the radius of turning circle comprises:
acquiring a current body orientation, a current body position and a target position of the self-moving machine when turning;
calculating an included angle between straight lines where the body orientation and the target position are located based on the current body orientation and the target position to obtain an angular difference;
calculating a difference between the current body position and the target position to obtain a position deviation; and
calculating the angular speed of the self-moving machine based on the target linear speed, the radius of turning circle, the angular difference and the position deviation.

10. The turning control method for the self-moving machine of claim 6, wherein the step of controlling, according to the target linear speed and the angular speed of the self-moving machine, the self-moving machine to turn at the target point according to the preset turning path comprises:
calculating speeds of left and right wheels based on the target linear speed and the angular speed of the self-moving machine; and
controlling, according to the speeds of the left and right wheels, the self-moving machine to turn at the target turning point according to the preset turning path.

11. The turning control method for the self-moving machine of claim 1, wherein the step of controlling, when the self-moving machine reaches the initial turning point, the self-moving machine to move back to a target turning point comprises:
acquiring, when the self-moving machine reaches the initial turning point, a path distance among moving paths in the whole area where the self-moving machine moves;
calculating a second backward distance based on the path distance; and
controlling the self-moving machine to move back to the second backward distance to reach the target turning point.

12. The turning control method for the self-moving machine of claim 11, wherein the second backward distance is half of the path distance.

13. The turning control method for the self-moving machine of claim 1, wherein the step of determining an initial turning point based on the whole area comprises:
dividing the whole area to obtain data of a plurality of moving paths;
acquiring, when the self-moving machine moves, boundary point data based on the whole area; and
determining an initial turning point based on the data of the plurality of moving paths and the boundary point data.

14. A turning control device for a self-moving machine, comprising:
an acquisition module, configured for acquiring a whole area where the self-moving machine moves;
a determination module, configured for determining an initial turning point based on the whole area; and
a control module, configured for controlling, when the self-moving machine reaches the initial turning point, the self-moving machine to move back to a target turning point;
wherein the control module is further configured for controlling the self-moving machine to turn at the target turning point according to a preset turning path to reach a target point in the whole area.

15. The turning control device for the self-moving machine of claim 14, wherein the control module is further configured for:
acquiring a coordinate of a current position point, the initial turning point, the target turning point and a position coordinate of the target point when the self-moving machine is turning;
calculating an inclination angle of the self-moving machine based on the coordinate of the current position point and a position coordinate of the initial turning point;
calculating a current progress of the self-moving machine by using dichotomy based on the inclination angle of the self-moving machine;
calculating a preset turning path based on the current progress of the self-moving machine, the initial turning point, the target turning point and the position coordinate of the target point; and
controlling the self-moving machine to turn at the target turning point according to the preset turning path to reach the target point in the whole area.

16. The turning control device for the self-moving machine of claim 15, wherein the control module is further configured for:
calculating path point data when turning based on the current progress of the self-moving machine, the initial turning point, the target turning point and the position coordinate of the target point; and
connecting all the path point data to form the preset turning path.

17. A self-moving machine, comprising a head, a body, a moving machine and a controller, wherein the head is detachably connected to the body, the moving machine and the controller are arranged on the body, the controller is used for controlling the moving machine to turn, the controller is able to run a turning control program of the self-moving machine, and the turning control program of the self-moving machine is configured to further realize the following steps:
acquiring a whole area where the self-moving machine moves;
determining an initial turning point based on the whole area;
controlling, when the self-moving machine reaches the initial turning point, the self-moving machine to move back to a target turning point; and
controlling the self-moving machine to turn at the target turning point according to a preset turning path to reach a target point in the whole area.

18. The self-moving machine of claim 17, wherein the self-moving machine is a crawler-type mower.

19. The self-moving machine of claim 17, wherein the turning control program of the self-moving machine is configured to further realize the following steps:
acquiring a coordinate of a current position point, the initial turning point, the target turning point and a position coordinate of the target point when the self-moving machine is turning;
calculating an inclination angle of the self-moving machine based on the coordinate of the current position point and a position coordinate of the initial turning point;
calculating a current progress of the self-moving machine by using dichotomy based on the inclination angle of the self-moving machine;
calculating a preset turning path based on the current progress of the self-moving machine, the initial turning point, the target turning point and the position coordinate of the target point; and
controlling the self-moving machine to turn at the target turning point according to the preset turning path to reach the target point in the whole area.

20. The self-moving machine of claim 19, wherein the turning control program of the self-moving machine is configured to further realize the following steps:
calculating path point data when turning based on the current progress of the self-moving machine, the initial turning point, the target turning point and the position coordinate of the target point; and
connecting all the path point data to form the preset turning path.
